(19) United States
(12) Patent Application Publication
(10) Pub. No.: US 2007/0220801 A1
(43) Pub. Date: Sep. 27, 2007

(54) Fishing lure holder

(76) Inventor: Bradley M. Clawson, Salt Lake City, UT (US)

Correspondence Address: Bradley M. Clawson, 2258 Gregson Ave, Salt Lake City, UT, 84109, US

(21) Appl. No.: 11/387,122

(22) Filed: Mar. 23, 2006

(51) Int. Cl. A01K 97/06

(52) U.S. Cl. 43/54.1; 43/57.1

(57) ABSTRACT

A cylindrical post to which fishing lures and most particularly fly fishing lures are attached. The post is affixed to the lid of a clear plastic bottle. Small permanent magnets are attached to the free end of the post and to the outside of the lid or bottom of the bottle. The various components are fastened together by a lanyard.

### BACKGROUND OF INVENTION

The present invention pertains to fishing lure holders that are used to view, select, withdraw and replace fishing lures. This invention is intended for use in fly-fishing abut can just as easily be used to hold artificial lures of all types of fishing. The following section describing the prior art will deal primarily with fishing lure holders used in fly-fishing.

Virtually all artificial fishing lure holders are box-like, rectangular or circular containers that are rarely more than 3 cm thick. All of these are either subdivided into small containers into which the lures are placed or provided with means of attaching the lures in the bottom of the box. Of the latter type the most commonly marketed method of securing the lures is with soft, foam like, serrated material into which the hooks are stuck. Others use magnets in various ways to secure the lures in the box.

The present invention combines several of these characteristics into a single cylindrical container holding a serrated, cylindrical post made of a soft, foam-like material into which the hooks of artificial fishing lures are stuck. The clear plastic, cylindrical container makes it easy to identify which lure to select. The cylindrical shape makes it easy to place and remove the lures onto the post. Magnets are also used inside and outside the container for temporarily holding the lures while they are being taken off of or put on a fishing line, or for catching loose lures in the container.

There are some U.S. Patents with similar characteristics to the present invention but do not approximate it. 1) U.S. Pat. No. 5,410,836 by Hardy in 1994 depicts a multiplicity of cylindrical tubes attached side by side. Fishing flies of the same type are placed into each tube but there is not a center post onto which the lures are attached. 2) U.S. Pat. No. 5,025,588 by Echols in 1990, depicts multiple, long, polygonal shaped, rotating posts in a box. 3) U.S. Pat. No. 6,516,555 by Buzzell in 2003, uses magnets in slots in a box in order to secure the fishing fly. 4) U.S. Pat. No. 5,555,671 by Voight, et al. in 1996, is a box, the bottom half of which contains a soft foam formed with serrations to allow the fishing flies to be attached.

### SUMMARY OF INVENTION

A new type of fishing lure holder consisting of a cylindrical post to which the fishing lures are attached. The post is attached to the lid of a clear plastic bottle and suspended in the center of the bottle. Permanent magnets are attached to the lid of the bottle and to the free end of the post for the purpose of holding loose lures. The lid and bottle are attached to each other with a lanyard, which may also be used to attach the device to the person using the device.

### BRIEF DESCRIPTION OF DRAWINGS

FIG. 1 is a perspective view of the Fishing Lure Holder.

### DETAILED DESCRIPTION

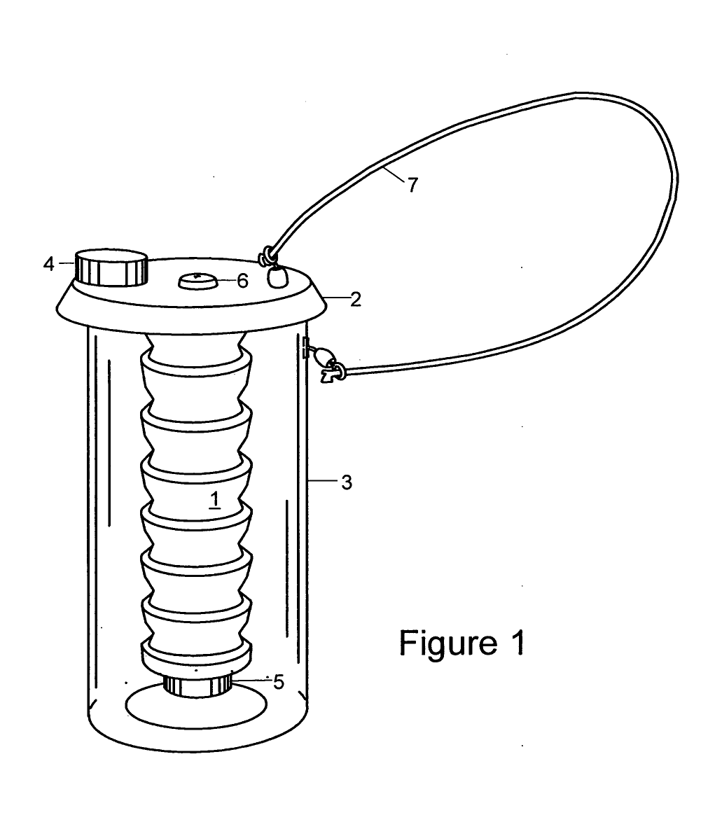

FIG. 1 shows a perspective view of the Fishing Lure Holder. The central post 1 is used to attach fishing lures. In the preferred embodiment the post is constructed of a closed cell, elastic foam such as polyurethane or E.V.A., cork or cork products. It is fashioned in a cylindrical shape with longitudinal ridges to which the fishing lures are attached. The distance separating the ridges may vary depending on the size of the lure that is intended to be stored.

The center post 1 is firmly attached to the lid 2 of a vial container 3 using glue appropriate to the materials of the center post and the lid, and/or by mechanical means such as a screw, nail or rivet 6. Also attached to the lid by similar means is a permanent magnet 4. The magnet is used to hold fishing lures or flies outside the lure holder while adding and/or removing a lure from the fishing line. For instance, while changing a lure, it is first removed from the fishing line and then placed on the magnet to be held there while opening the lure holder. When the lure holder is open the lure on the magnet is placed on the center post, a new lure is selected and placed on the exterior magnet while closing the lure holder, thus preventing the lure being dropped and possibly lost. A lanyard 7 is also attached to the lid and will be discussed later.

Another permanent magnet 5 is attached to the opposite end of the center post from the lid. The purpose of this second, interior magnet is: 1) to catch any lures that may come loose from the center post; 2) catch any lures that may be placed in the holder without attaching those to the center post and 3) to hold very small lures that are difficult to place on the center post of the holder.

The container is made of a clear plastic material to enable the user to easily and clearly see the lures inside. The material is of a durable nature to prevent it from being damaged when dropped from a height of 2 meters onto a hard surface.

The container and post are sized so that there is a space of about 2 mm between the bottom of the container and the bottom of the interior magnet.

A lanyard 7 is attached to the lid 2 and container 3 in such a way as to prevent it from coming loose. The lanyard is used to connect the two pieces of the device together and to allow the device to be connected to the clothing or equipment of the one using it.

1. A cylindrical post made of such material and configured in such a way as to allow fishing lures and flies to be attached thereon so they will not become easily dislodged during the use of the device.

2. The lid of a cylindrical container attached to one end of the device of claim 1, said lid allowing the device of claim 1 to be suspended in the center of the interior of a cylindrical vial.

3. A permanent magnet attached to the free end of the device of claim 1 to catch any fishing lures or flies that are loose in the bottle.

4. A container in the shape of a vial, referred to in claim 2, to encase and protect the cylindrical post of claim 1.

5. A permanent magnet attached to the lid of claim 2 for the purpose of temporarily holding a fishing lure or fly while the lure is being changed on the fishing line.

6. A lanyard connecting the lid and post in claims 1 and 2 to the container of claim 4. The lanyard may be used to attach the device to the clothing or equipment of the person using the device.

7. The material of the container of claim 4 is a clear plastic to enable the fishing lures and flies to be clearly seen while in the device being comprised of claims 1,2 and 3.

8. The material of the container of claim 4 is of a durable nature to prevent it from being damaged when dropped from a height of 2 meters onto a hard surface.
